(19) United States
(12) Patent Application Publication
(10) Pub. No.: US 2020/0011105 A1
(43) Pub. Date: Jan. 9, 2020

(54) PIECE OF FURNITURE AND ASSEMBLY FOR USE IN A PIECE OF FURNITURE

(71) Applicant: Julius Blum GmbH, Hoechst (AT)

(72) Inventor: Ingo GASSER, Hoechst (AT)

(21) Appl. No.: 16/576,918

(22) Filed: Sep. 20, 2019

Related U.S. Application Data
(63) Continuation of application No. PCT/AT2018/000033, filed on May 4, 2018.

(30) Foreign Application Priority Data
May 11, 2017 (AT) A 50398/2017

(51) Int. Cl. E05D 11/00; E05D 3/06

(52) U.S. Cl. CPC E05D 11/0054; E05D 2011/0072; E05Y 2900/20; E05D 3/06

(57) ABSTRACT

An item of furniture includes a first furniture part, a second furniture part, and at least two furniture hinges for pivotally connecting the first furniture part and the second furniture part. The furniture hinges are spaced from each other along a longitudinal direction of the furniture parts, and a gap is formed between the first furniture part and the second furniture part. A cover portion extends at least between the first furniture hinge and the second furniture hinge so that the gap can be at least partially covered. The first furniture part and the second furniture part can be moved by the at least two furniture hinges into a position in which the first furniture part and the second furniture part are aligned substantially coplanar relative to one another. The cover portion, in the coplanar position, is substantially fully covered by the first furniture part and/or the second furniture part.

### BACKGROUND OF THE INVENTION

The present invention relates to an item of furniture having a first furniture part, a second furniture part and at least two furniture hinges by which the first furniture part and the second furniture part are pivotally connected to one another, wherein the furniture hinges are spaced from each other along a longitudinal direction of the furniture parts, and wherein a gap is formed between the first furniture part and the second furniture part, wherein at least one cover portion is provided which extends at least between the first furniture hinge and the second furniture hinge and by which the gap can be at least partially covered, wherein the first furniture part and the second furniture part can be moved by the at least two furniture hinges into a position in which the first furniture part and the second furniture part are aligned substantially coplanar relative to one another.

Between two furniture parts, which are connected by two or more furniture hinges to one another, a gap can be formed in at least one relative position of the furniture parts, and the gap can cause a painful contusion upon an engagement of fingers and upon a subsequent relative movement of the furniture parts to one another. Moreover, the hinge mechanisms of the furniture hinges can be seen through the gap which does not satisfy the need for esthetics and defined lines. Moreover, the entry of dirt through the gap and into the furniture carcass is enabled.

EP 2 899 344 A1 discloses an arrangement having two furniture hinges spaced from each other and a cover portion. By the cover portion, a gap formed between two door wings connected to the furniture hinges in the mounted position can be covered. The cover portion is coupled to a movement of the furniture hinges, so that the cover portion, in a coplanar position of the door wings relative to one another, is arranged between the door wings. In a parallel position of the door wings, the cover portion is arranged in front of the gap. Accordingly, the cover portion is visible for a person in all operating positions, which is disturbing from an optical perspective. Moreover, there is frequently the desire that the outer gap appearance of the item of furniture is uniform to the gap appearance of adjacent items of furniture, in which the cover portion, which is always visible, may also bother.

### SUMMARY OF THE INVENTION

It is an object of the present invention to propose an item of furniture mentioned in the introductory part, in which at least one of the above-discussed drawbacks is avoided.

According to the invention, it is provided that the at least one cover portion, in the coplanar position of the furniture parts, is substantially fully covered by the first furniture part and/or by the second furniture part.

Accordingly, the cover portion in a position, in which the furniture parts are aligned coplanar to one another, is practically invisible for a person. Accordingly, the gap formed between the furniture parts can be dimensioned with a predefined standard size and can be configured so as to be uniform with the gap sizes of adjacent items of furniture.

Moreover, it can be provided that the first furniture part and the second furniture part can be moved by the at least two furniture hinges into a position in which the first furniture part and the second furniture part are aligned substantially parallel to one another, and the at least one cover portion, in the parallel position of the furniture parts, is arranged between the furniture parts. In this way, the cover portion can be configured so as to have a very narrow width and comes very discreet into appearance in the parallel position of the furniture parts.

Thereby, it can be provided that at least one furniture hinge has a hinge axis, and a longitudinal direction of the cover portion extends substantially parallel to the direction of the hinge axis of the furniture hinge.

According to an embodiment, it can be provided that the cover portion is connected or is configured to be, preferably releasably, connected to at least one furniture hinge.

It is also possible that the first furniture part and the second furniture part are pivotally connected to one another by three or more furniture hinges, and the cover portion extends at least between the three or more furniture hinges.

A width of the cover portion can be dimensioned such that the cover portion has a width being less than a width of the largest gap being present.

Protection is also sought for an arrangement to be used for such an item of furniture, and the arrangement comprises a first furniture hinge, a second furniture hinge and a cover portion of the described type.

### BRIEF DESCRIPTION OF DRAWINGS

Further details and advantages of the present invention result from the embodiment shown in the drawings, in which:

FIG. 1a, 1b show an item of furniture having a first furniture part and a second furniture part in an open position and in a closed position,

FIG. 2a, 2b show the furniture parts in a parallel position to one another, and an enlarged detail view thereof,

FIG. 3a, 3b show the furniture in an angled position to one another, and an enlarged detail view thereof,

FIG. 4 shows the furniture parts in a coplanar position to one another,

FIG. 5a-5d show a movement sequence of the furniture parts, starting from a parallel position into a coplanar position to one another,

FIG. 6a, 6b show an embodiment of a furniture hinge in a perspective view and in an exploded view.

### DETAILED DESCRIPTION OF THE INVENTION

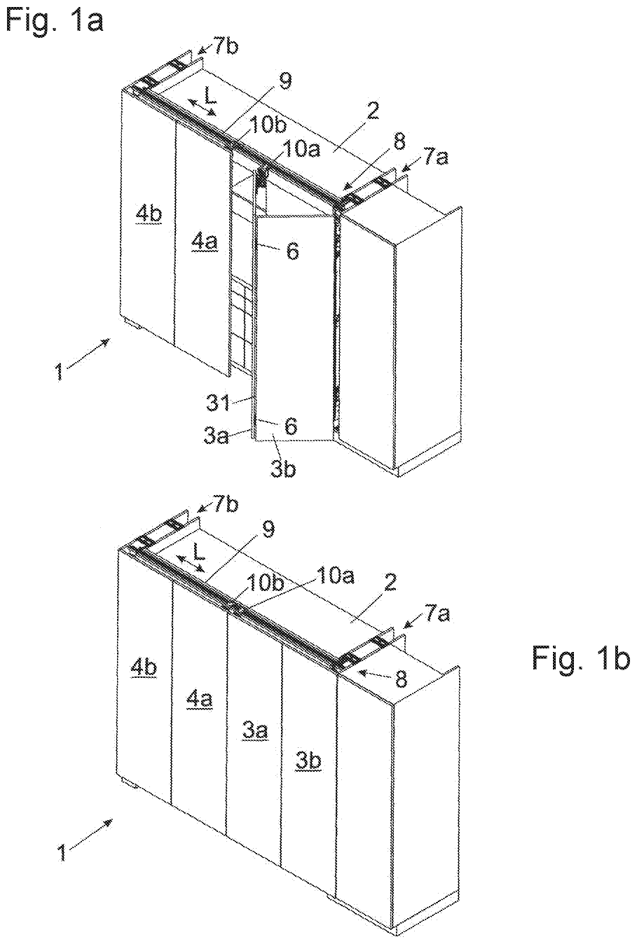

FIG. 1a shows an item of furniture 1 having a furniture carcass 2, in which each of a first furniture part 3a and a second furniture part 3b can be moved relative to the furniture carcass 2. The first furniture part 3a and the second furniture part 3b are pivotally connected to one another by at least two furniture hinges 6. However, three or more furniture hinges 6 spaced from each other may be also provided. Furniture hinges 6 which are configured so as to pivotally connect two movably-mounted furniture parts 3a, 3b are frequently denoted as middle hinges. Moreover, two further furniture parts 4a, 4b may be provided, and each of the furniture parts 4a, 4b are also pivotally connected to one another by furniture hinges 6. A vertical gap 31 is formed between the first furniture part 3a and the second furniture part 3b. The gap 31 can cause serious injuries to persons upon a possible finger engagement, causes a visually disturbing view onto the furniture hinges 6 and facilitates the intrusion of dirt into the furniture carcass 2.

The furniture parts 3a, 3b and 4a, 4b are movably supported relative to the furniture carcass 2 by a guide system 8. In the shown embodiment, the furniture parts 3a, 3b; 4a, 4b are movably supported by the guide system 8 between a first position, in which the furniture parts 3a, 3b; 4a, 4b are aligned substantially parallel to one another, and a second position, in which the furniture parts 3a, 3b; 4a, 4b are aligned substantially coplanar to one another (FIG. 1b). In the first position, in which the furniture parts 3a, 3b; 4a, 4b are aligned parallel to one another, the furniture parts 3a, 3b; 4a, 4b can be moved in pairs into a cavity 7a, 7b arranged laterally besides the furniture carcass 2. The guide system 8 includes a first guide rail 9 having a longitudinal direction (L) for guiding the furniture parts 3a, 3b; 4a, 4b. The guide system 8 further includes at least one second guide rail (not visible here), the second guide rail extending at a right angle relative to the longitudinal direction (L) of the first guide rail 9 in the mounted condition and by which each of the furniture parts 3a, 3b; 4a, 4b can be inserted into and extended from the lateral cavities 7a, 7b. The furniture part 3a is connected to a guide device 10a configured to be displaced along the first guide rail 9. The furniture 4a, on the contrary, is connected to a further guide device 10b which is also configured to be displaced along the first guide rail 9. FIG. 1b shows the furniture parts 3a, 3b; 4a, 4b in a closed position in which the furniture parts 3a, 3b; 4a, 4b are aligned coplanar to one another.

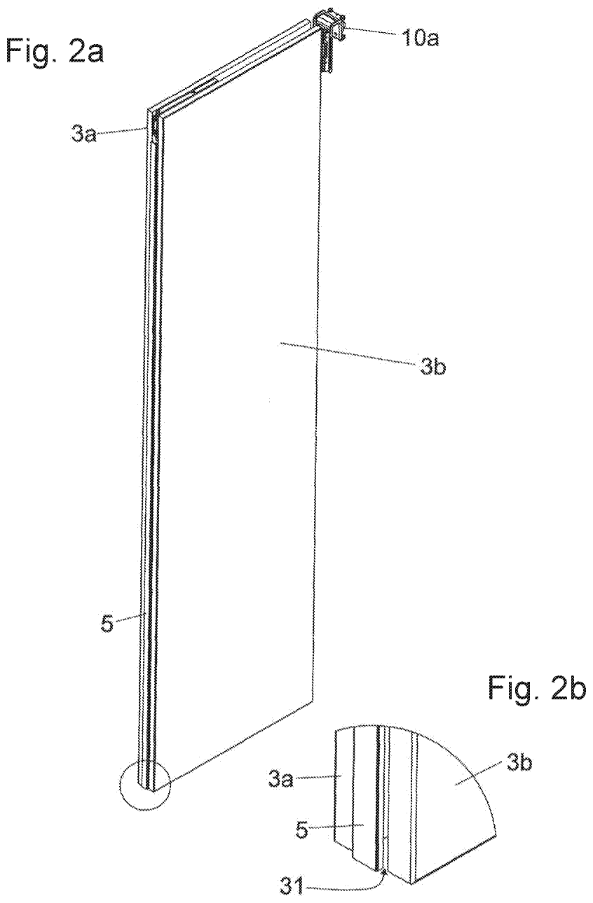

FIG. 2a shows a perspective view of the furniture parts 3a, 3b which, in the shown figure, adopt a parallel position to one another and can thereby be moved into and out from the lateral cavity 7a (FIG. 1a, 1b). Also visible is the guide device 10a connected to the first furniture part 3a, the guide device 10a being configured to be moved along the first guide rail 9. A lengthy gap 31 is formed between the furniture parts 3a, 3b, and the gap 31 can be at least partially covered by a cover portion 5. The cover portion 5 extends at least between two furniture hinges 6 spaced from each other in a longitudinal direction (H) of the furniture parts 3a, 3b. FIG. 2b shows the region encircled in FIG. 2a in an enlarged view, in which the cover portion 5 covers the gap 31 and can thereby protrude at least partially from the narrow sides of the furniture parts 3a. The cover portion 5 can be configured as a profiled rail, preferably U-shaped in a cross-section, for example made of metal or plastic.

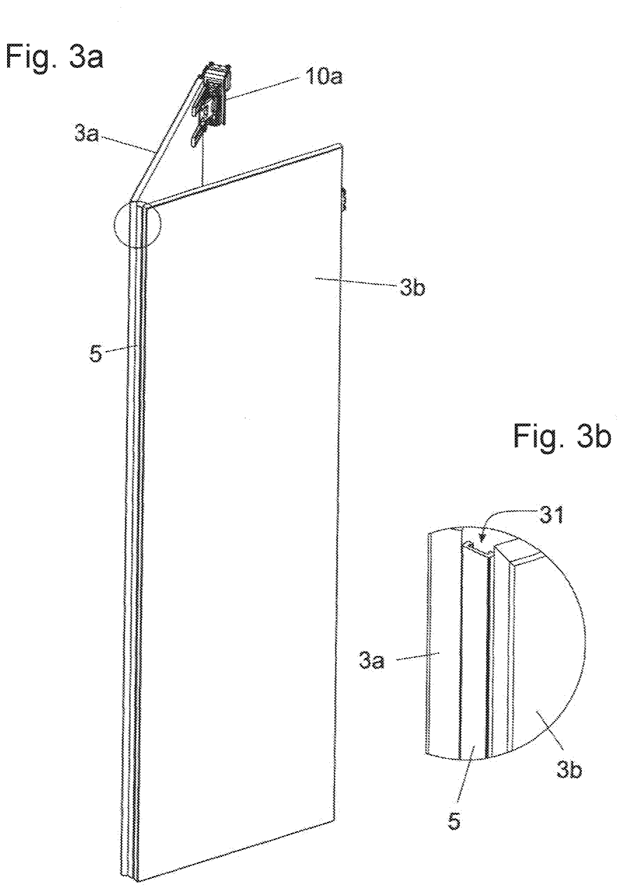

FIG. 3a shows the furniture parts 3a, 3b which adopt an angled position to one another. It is visible that the cover portion 5—starting from the (first) parallel position of the furniture parts 3a, 3b according to FIG. 2b in which the cover portion 5 protrudes over the narrow sides of the furniture parts 3a, 3b—upon a movement of the furniture parts 3a, 3b in a direction of the second position in which the furniture parts 3a, 3b adopt a coplanar position to one another—continually retracts in a direction of a depth of the furniture carcass 2.

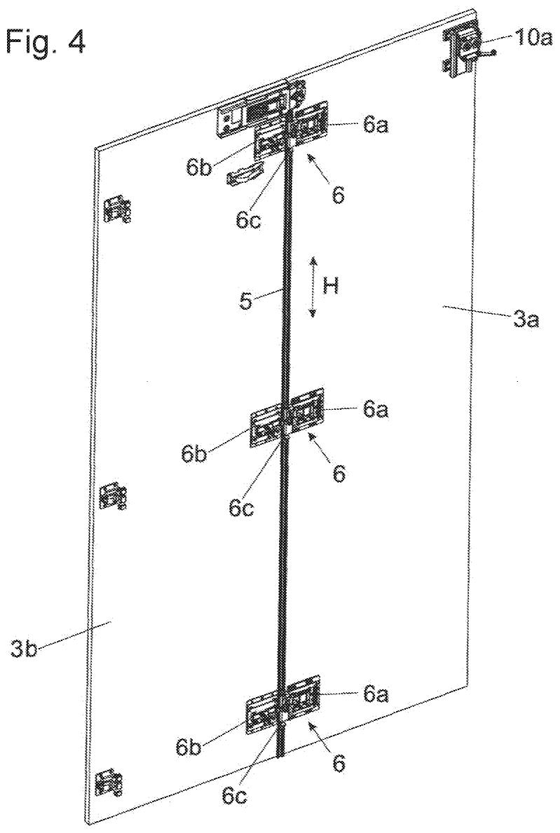

FIG. 4 shows the back side of the two furniture parts 3a, 3b which, in the shown figure, adopt a coplanar position to one another. The first furniture part 3a and the second furniture part 3b are pivotally connected to one another by two or more furniture hinges 6, and each of the furniture hinges 6 includes a first fitting portion 6a to be fixed to the first furniture part 3a and a second fitting portion 6b to be fixed to the second furniture part 3b. Each of the first fitting portions 6a and second fitting portions 6b are pivotally connected to one another by at least one hinge axis 6c. The furniture hinges 6 are spaced from each other in a longitudinal direction (H) of the furniture parts 3a, 3b, and the cover portion 5 extends between at least two furniture hinges 6. In the coplanar position of the furniture parts 3a, 3b, the cover portion 5 is in a retracted position, so that the cover portion 5 is not visible from the front in that relative position of the furniture parts 3a, 3b.

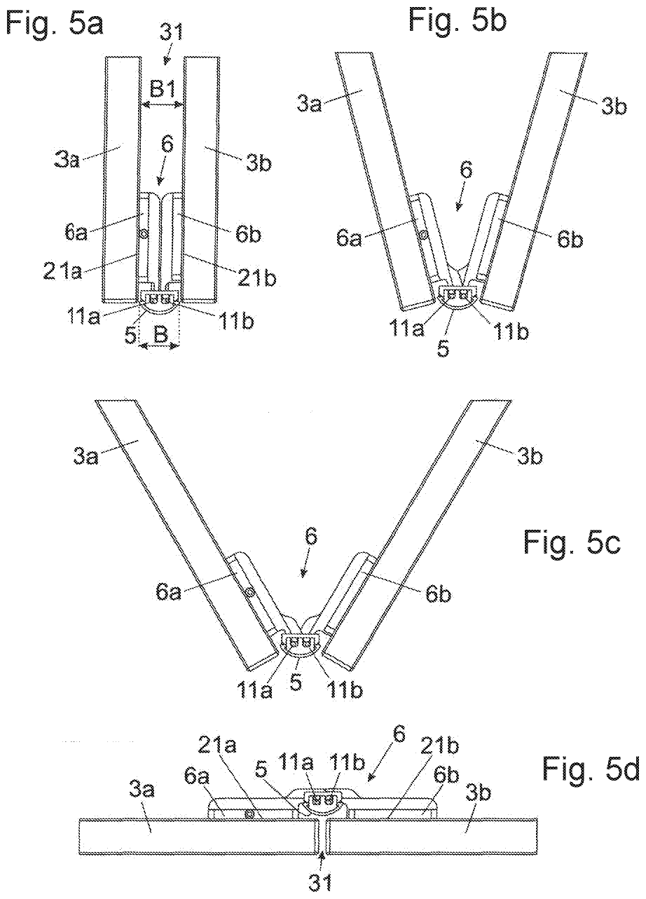

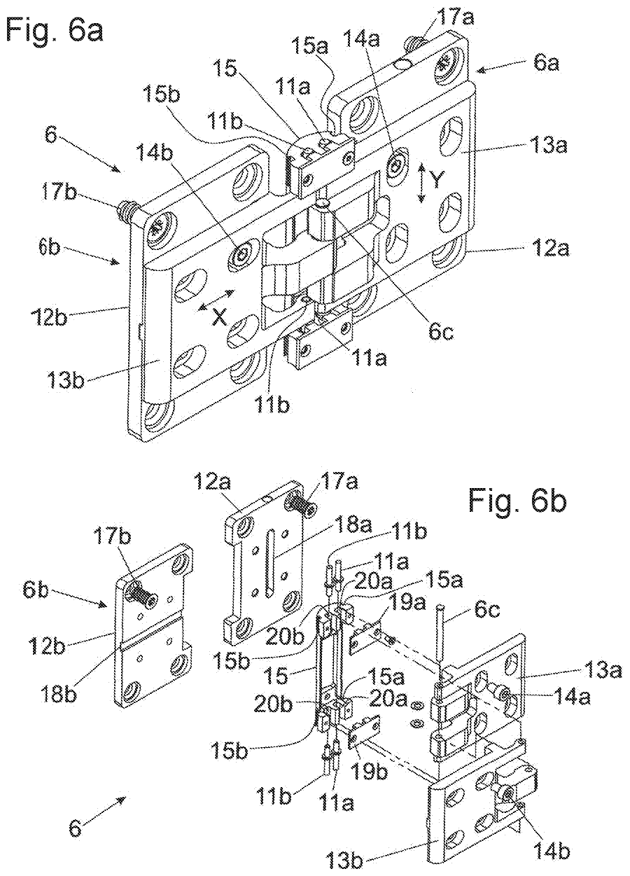

FIG. 5a-5d show a movement of the furniture parts 3a and 3b, starting from a parallel position into a coplanar position to one another. The first fitting portion 6a is fixed to the first furniture part 3a, the second fitting portion 6b is fixed to the second furniture part 3b, and the two fitting portions 6a, 6b are pivotally connected to one another by the hinge axis 6c shown in FIG. 4. The cover portion 5 is connected to at least one furniture hinge 6 or, alternatively, is configured to be, preferably releasably, connected to at least one furniture hinge 6. The cover portion 5 can be configured so as to be movable relative to the fitting portions 6a, 6b, and a movement of the cover portion 5 can be coupled to a relative movement of the fitting portions 6a, 6b to one another. For controlling a movement of the cover portion 5, the first fitting portion 6a includes a first guide pin 11a and the second fitting portion 6b includes a second guide pin 11b. Each of the first guide pin 11a and the second guide pin 11b are arranged so as to be offset to the hinge axis 6c and are each guided with clearance within a recess 20a, 20b (FIG. 6b) of a bearing body 15, the bearing body 15 being connected or being releasable connectable to the cover portion 5. In FIG. 5a, the parallel position of the furniture parts 3a, 3b is shown, in which the cover portion 5 protrudes at least partially over the narrow sides of the furniture parts 3a, 3b. In the shown embodiment, the cover portion 5 has a curved-shaped or an embossed peripheral surface. When now the furniture parts 3a and 3b are pivoted relative to one another (FIG. 5b), the cover portion 5 is entrained by a relative movement of the fitting portions 6a, 6b. In a further position of the furniture parts 3a, 3b to one another (FIG. 5c), the cover portion 5 is continually retracted. In the coplanar position of the furniture parts 3a, 3b (FIG. 5d), the cover portion 5 is arranged on a back side of the first furniture part 3a and/or on a back side of the second furniture part 3b, so that the cover portion 5 is practically invisible from the front in the coplanar position of the furniture parts 3a, 3b.

The furniture hinges 6 include a first abutment surface 21a for resting against the first furniture part 3a and a second abutment surface 21b for resting against the second furniture part 3b, and a width (B) of the at least one cover portion 5, in the parallel position of the furniture parts 3a, 3b (FIG. 5a), is smaller than a distance (B1) formed between the abutment surfaces 21a, 21b of the furniture hinges 6. In the coplanar position of the furniture parts 3a, 3b (FIG. 5d), the at least one cover portion 5 is arranged so as to be set back relative to the first and second abutment surface 21a, 21b of the furniture hinges 6.

FIG. 6a shows a perspective view of a furniture hinge 6 which includes a first fitting portion 6a to be fixed to the first furniture part 3a and a second fitting portion 6b to be fixed to the second furniture part 3b, and the fitting portions 6a, 6b are pivotally connected to one another by at least one hinge axis 6c. The first fitting portion 6a includes a first base plate 12a to be fixed to the first furniture part 3a by at least one first fastening means 17a. A first adjusting plate 13a is movably supported on the first base plate 12a, and by an actuation of a first adjustment device 14a, a position of the first adjusting plate 13a can be adjusted, preferably in a vertical direction (Y), relative to the first base plate 12a. In this way, the furniture parts 3a, 3b are adjustable relative to one another in a height direction in a mounted condition. The second fitting portion 6b includes a second base plate 12b to be fixed to the second furniture part 3b by at least one second fastening means 17b. A second adjusting plate 13b is movably supported on the second base plate 12b, and by an actuation of a second adjustment device 14b, a position of the second adjusting plate 13b can be adjusted, preferably in a lateral direction (X), relative to the second base plate 12b. In this way, the furniture parts 3a, 3b are adjustable relative to one another in a lateral direction in a mounted condition. In the shown figure, each of the adjustment devices 14a, 14b includes clamping screws configured to be displaced within an elongated hole of the adjusting plates 13a, 13b. For adjustment purposes, the clamping screws are to be released, the adjustment of the adjusting plates 13a, 13b relative to the base plates 12a, 12b to be performed, and, subsequently, the clamping screws are again to be tightened. However, at least one of the adjustment devices 14a, 14b can have a self-locking configuration, and by an actuation of an adjustment element, a—preferably continuous—adjustment of the adjusting plates 13a, 13b relative to the base plates 12a, 12b can be brought about.

The furniture hinge 6 includes a bearing body 15 which is connected or which is configured to be releasably connected to the cover portion 5. Hereby, guides 15a, 15b can be formed or arranged on the bearing body 15 for example, and the cover portion 5 is configured to be inserted into or is configured to be snapped onto the guides 15a, 15b of the bearing body 15. Of course, the cover portion 5 can also be fixed to the bearing body 15 by other force-locking or form-locking connections. Arranged on the first adjusting plate 13a are upper and lower (first) guide pins 11a, while upper and lower (second) guide pins 11b are arranged on the second adjusting plate 13b. Each of the first and second guide pins 11a, 11 b engage into a recess 20a, 20b (FIG. 6b) of the bearing body 15 and are guided with clearance within the recesses 20a, 20b of the bearing body 15.

FIG. 6b shows the furniture hinge 6 in an exploded view. At least one first linear guide 18a is provided on the first base plate 12a of the first fitting portion 6a for the adjustable support of the first adjusting plate 13a in a direction (Y), while at least one second linear guide 18b is formed or arranged on the second base plate 12b of the second fitting portion 6b for the adjustable support of the second adjusting plate 13b. The bearing body 15 has upper and lower recesses 20a and 20b in which the upper and lower guide pins 11a, 11b of the adjusting plates 13a, 13b are guided with clearance. In order to cover the upper and lower recesses 20a, 20b, upper and lower cover plates 19a, 19b are provided configured to be fixed to the bearing body 15 by screws.

In contrast to the shown figures, the cover portion 5 can not only be provided for covering a vertically extending gap 31, but also for covering a horizontally extending gap 31, and the second furniture part 3b is pivotally supported relative to the first furniture part 3a about a horizontally extending axis.

1. An item of furniture comprising:
a first furniture part;
a second furniture part; and
at least two furniture hinges by which the first furniture part and the second furniture part are pivotally connected to one another,
wherein the furniture hinges are spaced from each other along a longitudinal direction of the furniture parts, and a gap is formed between the first furniture part and the second furniture part,
wherein at least one cover portion is provided which extends at least between the first furniture hinge and the second furniture hinge and by which the gap can be at least partially covered,
wherein the first furniture part and the second furniture part can be moved by the at least two furniture hinges into a position in which the first furniture part and the second furniture part are aligned substantially coplanar relative to one another, and
wherein the at least one cover portion, in the coplanar position of the furniture parts, is substantially fully covered by the first furniture part and/or by the second furniture part.

2. The item of furniture according to claim 1, wherein the first furniture part and the second furniture part can be moved by the at least two furniture hinges into a position in which the first furniture part and the second furniture part are aligned substantially parallel to one another, wherein the at least one cover portion, in the parallel position of the furniture parts, is arranged between the furniture parts.

3. The item of furniture according to claim 1, wherein at least one furniture hinge has a first abutment surface for resting against the first furniture part and a second abutment surface for resting against the second furniture part, wherein the at least one cover portion, in that position of the furniture parts in which the furniture parts are aligned substantially coplanar to one another, is arranged so as to be set back from the first and second abutment surfaces of at least one furniture hinge.

4. The item of furniture according to claim 3, wherein a width of the at least one cover portion, in that position of the furniture parts in which the furniture parts are aligned substantially parallel to one another, is smaller than a distance formed between the abutment surfaces of the furniture hinges.

5. The item of furniture according to claim 1, wherein at least one furniture hinge has a hinge axis, wherein a longitudinal direction of the cover portion extends substantially parallel to the direction of the hinge axis of the furniture hinge.

6. The item of furniture according to claim 1, wherein the cover portion is connected or is configured to be, preferably releasably, connected to at least one furniture hinge.

7. The item of furniture according to claim 1, wherein the first furniture part and the second furniture part are pivotally connected to one another by three or more furniture hinges, wherein the cover portion extends at least between the three or more furniture hinges.

8. The item of furniture according to claim 2, wherein the cover portion, in that position of the furniture parts in which the furniture parts are aligned substantially parallel to one another, protrudes at least partially from the furniture parts.

9. The item of furniture according to claim 1, wherein the cover portion, in that in that position of the furniture parts in which the furniture parts are aligned substantially coplanar to one another, is arranged on a back side of the first furniture part and/or on a back side of the second furniture part.

10. The item of furniture according to claim 1, wherein at least one furniture hinge includes a first fitting portion fixed to the first furniture part and a second fitting portion fixed to the second furniture part, wherein the first fitting portion and the second fitting portion are pivotally supported relative to one another about the at least one hinge axis of the furniture hinge upon a relative movement to one another.

11. The item of furniture according to claim 10, wherein the cover portion is movably supported relative to the at least one furniture hinge, wherein a movement of the cover portion is coupled to a relative movement of the fitting portions.

12. The item of furniture according to claim 10, wherein the cover portion, upon a relative movement of the fitting portions, is configured so as to be symmetrically movable relative to the furniture parts.

13. An arrangement to be used for an item of furniture according to claim 1, comprising a first furniture hinge, a second furniture hinge, and a cover portion which is connected or which is configured to be, preferably releasably, connected to the first furniture hinge and/or to the second furniture hinge.

14. The arrangement according to claim 13, wherein at least one of the furniture hinges includes a first fitting portion to be fixed to the first furniture part and a second fitting portion to be fixed to the second furniture part, wherein the first fitting portion and the second fitting portion are pivotally connected to one another by at least one hinge axis.

15. The arrangement according to claim 13, wherein at least one furniture hinge includes a bearing body which is connected or which is configured to be connected to the cover portion.

16. The arrangement according to claim 15, wherein the bearing body includes a first recess and at least one second recess, wherein a first guide pin of the first fitting portion is guided within the first recess with clearance and a second guide pin of the second fitting portion is guided within the second recess with clearance.

17. The arrangement according to claim 13, wherein the cover portion is configured as a profiled rail, preferably made of metal or plastic.
